(19) United States
(12) Patent Application Publication
(10) Pub. No.: US 2009/0295031 A1
(43) Pub. Date: Dec. 3, 2009

(54) METHOD AND APPARATUS FOR CASTING A CONCRETE PRODUCT

(75) Inventors: Heikki LEHTONEN, Toijala (FI); Aimo SEPPANEN, Saaksmaki (FI)

Correspondence Address: BUCHANAN, INGERSOLL & ROONEY PC, POST OFFICE BOX 1404, ALEXANDRIA, VA, 22313-1404, US

(73) Assignee: Elematic Group Oy, Toijala (FI)

(21) Appl. No.: 12/475,975

(22) Filed: Jun. 1, 2009

(30) Foreign Application Priority Data
Jun. 3, 2008 (FI) 20085541

(51) Int. Cl. B29C 39/22; B29B 7/42

(52) U.S. Cl. 264/299; 425/209

(57) ABSTRACT

Method and apparatus for casting a concrete product with a substantially horizontal slipform casting process, concrete mix in said method being fed by means of at least one feed screw (1) through a limited cross-section for forming the concrete product, whereby the feed screw (1) is brought to circular motion on a plane transversal with respect to the length of the feed screw.

The present invention relates to casting of a concrete product with a substantially horizontal slipform casting process, wherein concrete mix is fed through a limited cross-section for manufacturing a concrete product of a desired form. More precisely, the invention is related to the motion of feeding elements of an apparatus to be used in slipform casting.

In traditional casting machines of extruder type, concrete mix is fed from a concrete tank by means of hydrostatic pressure to feed screws, said feed screws extruding the concrete mix by means of rotating and reciprocating motion through a limited cross-section for providing a concrete product of a desired form. When casting hollow-core slabs, the feed screw is followed by a hollow-core mandrel forming a hollow core to the product to be cast. In addition, the aggregate formed by the feed screw and the hollow-core mandrel perform reciprocal motion for compacting the concrete mix. A mass chute is provided under and partly around the feed screw for guiding concrete mix around the hollow-core mandrel. Above the hollow-core mandrel and partly also above the feed screw there is located a compacting beam of the upper surface for defining the upper surface of the product to be cast, said compacting beam comprising a reciprocating throweling beam compacting and smoothing the upper surface of the product to be cast. The sides of the product to be cast are defined by sidewalls moving back and forth in the longitudinal direction, the movement compacting and smoothing the side surfaces of the product to be cast.

The feed screw performs compacting of the concrete mix by means of rotating motion causing the pressurized feed of the concrete mix to the limited cross section, and by means of reciprocal compacting motion.

In the solution disclosed in the Patent publication FI 118175, arched or in several phases eccentric feed screws are used, which when performing the rotating motion and the longitudinal reciprocal motion, compact the concrete mix by pressing it against each other and the mass chute and the side walls of the mold. Thereby, due to the eccentricity of the feed screws, the space between the screws and the space between the screw and the mass chute alternately increases and decreases, when the feed screws rotate, whereby the spaces, when they are at the largest, are filled with the concrete mix flowing from the concrete mix tank effected by the hydrostatic pressure. When the feed screws continue to rotate, the concrete mix in these spaces is compressed and compacted due to this compression.

In the solution in accordance with the publication FI 118175, the eccentricity of the eccentric feed screws is relatively big and the rotating motion is slow. Thus, in this solution, the eccentric motion is slow and has long movements. The compacting effect of the solution is limited to the area of the feed screw, where the concrete mix is not compacted or partly compacted.

In the solution according to the present invention, a feed screw acting as feeding means and an eventual hollow core forming means (a hollow-core mandrel) following the same, are brought to a rotational motion, which means substantially a circular motion on the plane transversal to the longitudinal direction of the aggregate formed by the feed screw and the hollow-core mandrel. This circular motion of the aggregate formed by the feed screw and the hollow-core mandrel intensifies the compacting of the concrete mix in addition to the rotating motion and the reciprocal longitudinal motion of the traditional feed screw.

The circular motion of the feed screw, and if necessary, of the hollow-core mandrel, according to the invention intensifies the compacting of the concrete mix over the total length of the feed screw and the hollow-core mandrel, and by means of the rotating direction of the circular motion, the intensifying of the compacting can be targeted to the desired direction and location of the limited cross section.

In the solution according to the invention, the ratio of the speed of the circular motion of the feed screw to the rotating speed of the feed screw is preferably ca. 10:1, and the radius of the circular motion is relatively small, which means that the eccentricity of the circular motion is small. This provides quick, short-motion compacting effect for the whole length of the feed screw and the eventual hollow-core mandrel following the same. This compacting caused by the circular motion effects in the area of the tail end portion of the feed screw and the forward end portion of the eventual hollow-core mandrel, where the pressure of the concrete mix is the strongest and the concrete mix still in a plasticized state.

More precisely, the solution according to the present invention is characterized by what is stated in the characterizing part of Claim 1, and the apparatus according to the present invention by what is stated in the characterizing part of Claim 5.

The invention will be described by way of example in more detail in the following, with reference to the enclosed drawings, wherein

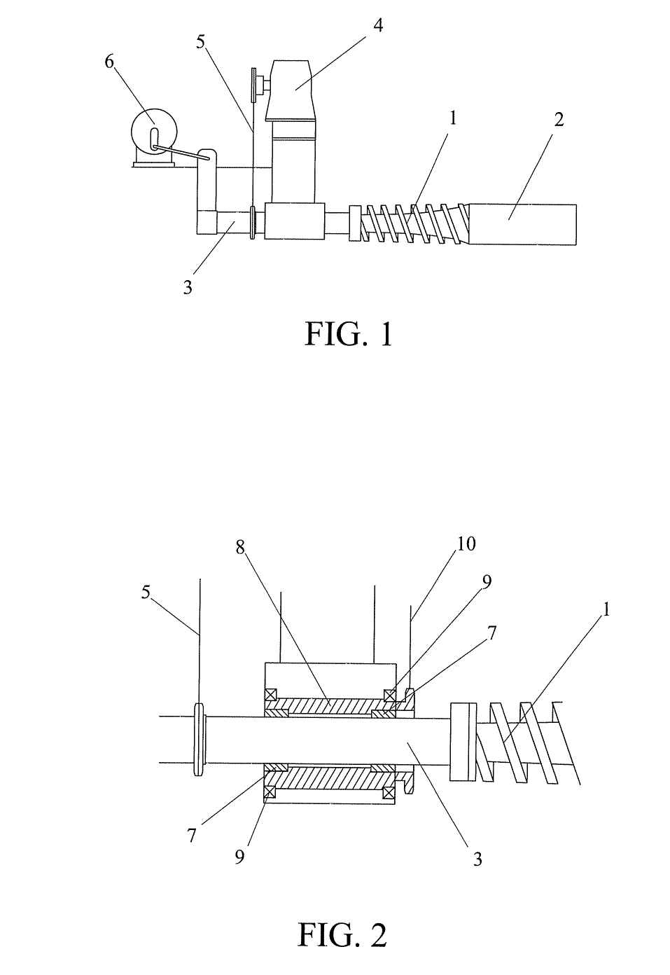

FIG. 1 shows a schematic view of operating devices of a feed screw of a traditional extruder-type slipform-casting machine, and

FIG. 2 shows a schematic view of one solution according to the invention for rotating the feed screw.

Essential parts of the traditional solution shown in FIG. 1 are a feed screw 1, hollow core forming element, in other words a hollow-core mandrel 2 to be attached following the feed screw when casting products equipped with hollow cores, drive shaft 3 of the feed screw, drive motor 4 for the rotating motion of the feed screw, drive chain 5 and a drive motor 6 for the longitudinal motion of the feed screw.

The rotating motion of the feed screw 1 is provided by the drive motor 4, from which the rotating motion is transmitted to the drive shaft 3 of the feed screw with the drive chain 5. In addition to the rotating motion, the feed screw 1 performs reciprocal compacting motion provided by the drive motor 6 and transmitted by a drive lever system to the drive shaft 3 of the feed screw.

FIG. 2 shows one solution for providing the circular motion according to the invention for the feed screw 1. A fixing point of the feed screw 1 is shown in the figure, through which the feed screw is fixed by means of its drive shaft 3 to the frame of the slipform casting machine. In the traditional solution, this fixing point is implemented by means of slide bearings 7, providing the rotation of the drive shaft 3 of the feed screw.

In the solution according to the invention, shown in FIG. 2, the drive shaft 3 of the feed screw is attached through slide bearings 7 to an eccentric bushing 8, which in turn is attached via bearings 9 to the frame of the slipform casting machine.

Slide bearings 7 enable the usual rotating motion of the feed screw, and the reciprocal compacting motion of the feed screw. The circular motion of the feed screw 1 is provided by rotating the eccentric bushing 8 supported by the bearings 9 to the frame of the slipform casting machine by means of a drive motor for separate circulating motion (not shown) and a drive chain 10.

As shown in FIG. 2, the power transmission for the circular motion of the feed screw 1 is in the solution according to the invention advantageously implemented from behind the bearing bracket with respect to the casting direction, in other words, from the opposite side with respect to the power transmission of the usual rotating motion of the feed screw. This kind of a solution is from the point of view of the machine construction simpler to implement and it evens the load exerted to the bearing brackets.

In the solution according to the invention, the circular motion of the feed screw and the eventually following hollow-core mandrel can be parallel with the rotating motion of the feed screw, or opposite thereto. The circular motion parallel with the rotating motion of the feed screw intensifies the feed of the concrete mix, whereas the opposite circular motion intensifies the compacting of the concrete mix.

In the solution according to the invention, the rotating speed of the circular motion of the feed screw and the eventually following hollow-core mandrel is preferably ca. from 400 to 800 rotations per minute, and the radius of the circular motion, that is the eccentricity, is preferably about from 1 to 3 mm.

The solution according to the invention is not limited to the slipform casting machine moving on a casting bed, but it can also be implemented as a fixed casting station, whereby the cast concrete product is moved out from the casting station with casting beds movable with respect to the fixed casting station.

1. A method for casting a concrete product with a substantially horizontal slipform casting process, concrete mix in said method being fed by means of at least one feed screw (1) through a limited cross-section for forming the concrete product, wherein the feed screw (1) is brought to circular motion on a plane transversal with respect to the length of the feed screw.

2. The method according to claim 1, wherein an aggregate formed by the feed screw (1) and a hollow-core mandrel (2) attached following the same is brought to said circular motion.

3. The method according to claim 1, wherein the rotating speed of the circular motion of the feed screw ranges from 400 to 800 rotations per minute.

4. The method according to claim 1, wherein the radius of the circular motion of the feed screw ranges from 1 to 3 mm.

5. The apparatus for casting a concrete product substantially with a horizontal slipform process, said apparatus comprising at least one feed screw (1) for feeding concrete mix through a limited cross section, wherein the apparatus comprises means (8, 9, 10) for bringing the feed screw (1) to a circular motion on a plane transversal with respect to the length of the feed screw.

6. The apparatus according to claim 5, wherein the apparatus comprises an aggregate formed by the feed screw (1) and a hollow-core mandrel (2) attached following the same, said aggregate being brought to said circular motion.

7. The apparatus according to claim 5, wherein the means for bringing the feed screw (1) to circular motion comprises an eccentric bushing (8), a drive motor for rotating the bushing, and power transmission means (10).

8. The method according to claim 2, wherein the rotating speed of the circular motion of the feed screw ranges from 400 to 800 rotations per minute.

9. The method according to claim 2, wherein the radius of the circular motion of the feed screw ranges from 1 to 3 mm.

10. The method according to claim 3, wherein the radius of the circular motion of the feed screw ranges from 1 to 3 mm.

11. The method according to claim 8, wherein the radius of the circular motion of the feed screw ranges from 1 to 3 mm.

12. The apparatus according to claim 6, wherein the means for bringing the feed screw (1) to circular motion comprises an eccentric bushing (8), a drive motor for rotating the bushing, and power transmission means (10).
